(19) United States
(12) Patent Application Publication
(10) Pub. No.: US 2024/0290149 A1
(43) Pub. Date: Aug. 29, 2024

(54) Method and Apparatus for Defining the Significance of a Vehicle Communication Connection

(71) Applicant: Bayerische Motoren Werke Aktiengeselischaft, Muenchen (DE)

(72) Inventor: Alaa MOURAD, Muenchen (DE)

(21) Appl. No.: 18/425,672

(22) Filed: Jan. 29, 2024

(30) Foreign Application Priority Data
Feb. 28, 2023 (DE) 10 2023 104 930.5

(51) Int. Cl. G07C 9/00; H04W 76/11

(52) U.S. Cl. CPC G07C 9/00174; H04W 76/11; G07C 2009/00769

(57) ABSTRACT

Methods, systems, and apparatuses are provided for controlling a vehicle function via a first communication connection between a first vehicle and a device. A multiplicity of different communication connections is operated to a corresponding multiplicity of different vehicles. A significance message is sent to the device via the first communication connection. The significance message indicates a significance value for a significance of the first communication connection. The significance message is configured to prompt the device to define a connection parameter that is dependent on the significance value for the first communication connection. The significance message indicates a priority level from a predefined set of different priority levels. Alternatively, or in addition, the significance value for the significance of the first communication connection indicates a priority of the first communication connection in comparison with one or more other communication connections.

This application claims priority under 35 U.S.C. § 119 from German Patent Application No. 10 2023 104 930.5, filed Feb. 28, 2023, the entire disclosure of which is herein expressly incorporated by reference.

### BACKGROUND AND SUMMARY

The present subject matter relates to a method and a corresponding apparatus for remotely controlling one or more vehicle functions of different vehicles by means of a common device.

A vehicle may have one or more functions that can be remotely controlled by a user of the vehicle using an electronic device, such as a smartphone. An example of a vehicle function is the opening and/or closing of a door or flap of the vehicle. The one or more vehicle functions are remotely controlled via a wireless communication connection between the vehicle and the electronic device.

It may be possible for a user to remotely control vehicle functions in different vehicles using an electronic device. For example, it may be possible for the operator of a fleet to remotely control functions in different vehicles in the fleet using a single electronic device.

The present document deals with the technical object of enabling particularly efficient, reliable and convenient remote control of a vehicle function in a vehicle using a device which can simultaneously be used to remotely control vehicle functions in a plurality of different vehicles.

One aspect describes an apparatus for controlling a vehicle function via a first communication connection between a first (motor) vehicle and a device. The device can be designed, for the remote control of vehicle functions (of the respective vehicles), to operate a multiplicity of different communication connections to a corresponding multiplicity of different vehicles. The apparatus can be part of the first vehicle.

The individual communication connections between the device and the individual vehicles may have each been established considering a digital key. The digital key may be designed according to a Car Connectivity Consortium, CCC, key standard, in particular according to CCC Release 3. The digital key may be designed to enable the device to control one or more vehicle functions of the respective vehicle.

The apparatus can be configured to remotely control one or more vehicle functions of the first vehicle via the (BLE) communication connection between the device and the first vehicle. For this purpose, one or more control commands for remotely controlling the one or more vehicle functions of the first vehicle (which have been sent by the device) can be received via the first communication connection. Examples of vehicle functions are the opening and/or closing of a vehicle door and/or the starting and/or stopping of the drive motor of the vehicle and/or the automated and/or remotely controlled parking of the vehicle.

The apparatus is configured to send a significance message to the device via the first communication connection. In this case, the significance message can indicate a significance value for the significance of the first communication connection. The significance message can in particular indicate the priority level from a predefined set of different priority levels (e.g. low priority, medium priority and/or high priority). Alternatively, or additionally, the significance value for the significance of the first communication connection can indicate the priority of the first communication connection, in particular in comparison with one or more other communication connections.

It can thus be made possible for the first vehicle (even for a first communication connection that already exists) to send a significance message to the device in order to indicate to the device the significance (desired by the vehicle) of the communication connection. The significance message can be configured to prompt the device to define a connection parameter, which is dependent on the significance value, for the first communication connection.

The individual communication connections of the multiplicity of communication connections can each include, in particular be, a Bluetooth Low Energy (BLE) communication connection. The connection parameter to be determined for the first communication connection may comprise, in particular be, the temporal length of connection intervals of the BLE communication connection.

The device can have a limited amount of total resources for communicating with the multiplicity of vehicles. The connection parameters for the individual communication connections can be determined in such a way that the respective proportion of the total resources of the individual communication connections increases with increasing significance of the respective communication connection and/or decreases with decreasing significance of the respective communication connection.

The provision of a significance value for the first communication connection can enable particularly efficient, reliable and convenient remote control of the vehicle functions of the first vehicle by means of a (key) device.

As already explained further above, the connection parameter may comprise, in particular be, the temporal length of connection intervals of the first BLE communication connection. The temporal length of connection intervals can be determined in such a way that
the temporal length of the first communication connection is less than the temporal length of a (any) second communication connection when the significance values indicate a higher significance of the first communication connection than the second communication connection; and/or
the temporal length of the first communication connection is greater than the temporal length of a (any) second communication connection when the significance values indicate a lower significance of the first communication connection than the second communication connection; and/or
the temporal length of connection intervals of the first communication connection decreases with increasing significance and/or increases with decreasing significance.

Particularly efficient, reliable and convenient remote control of the vehicle function of the first vehicle can thus be brought about.

The significance value for the first communication connection can depend on the vehicle function that is intended to be controlled via the first communication connection. For this purpose, the apparatus may be configured to determine the vehicle function of the first vehicle that is intended to be remotely controlled or is remotely controlled via the first communication connection between the device and the first vehicle. The significance value for the significance of the first communication connection between the device and the first vehicle can then be determined in a precise manner on the basis of the vehicle function (in particular on the basis of a latency requirement of the vehicle function) that is intended to be remotely controlled or is remotely controlled via the first communication connection. A predefined significance catalog which indicates a respective corresponding significance value for different vehicle functions can be considered.

The apparatus may be configured, repeatedly, at successive times, in each case to determine an updated significance value (for example, on the basis of a(n) (optionally changed) vehicle function). A significance message with the respectively updated significance value can then be sent in each case. Furthermore, the device (based on the respectively updated significance value) can update the connection parameter for the first communication connection. Repeatedly updating the significance value and/or the connection parameter makes it possible to permanently increase the quality of the remote control of vehicle functions.

The significance message is preferably a message according to the CCC standard or protocol. Alternatively, or additionally, the significance message can be sent on the same protocol layer (e.g. on the application layer) as the digital key. In addition, the significance message can be sent on a different protocol layer, in particular on a (logically) higher protocol layer (according to the OSI model), than the protocol layer used for the (BLE) communication connection. This enables particularly robust and flexible remote control of a vehicle function.

As explained further above, the significance message can make it possible for a vehicle to define a priority. If necessary, the priority can be associated with the digital key for the vehicle. In particular, the device may associate the digital key of the vehicle with a certain priority level. Accordingly, the digital keys of the multiplicity of vehicles can each be associated with a priority level. The connection parameters of the individual communication connections can then be defined based on the priority levels of the digital keys of the corresponding vehicles. In particular, the significance values can be determined on the basis of the priority levels associated with the respective digital key. This allows the quality of the remote control to be further increased.

A further aspect describes a (road) motor vehicle (in particular an automobile or a truck or a bus or a motorcycle) which comprises the apparatus described in this document.

A further aspect describes a method for controlling a vehicle function via a first communication connection between a first vehicle and a device. The device is designed, for the remote control of vehicle functions, to operate a multiplicity of different communication connections to a corresponding multiplicity of different vehicles. The method comprises sending a significance message to the device via the first communication connection. In this case, the significance message can indicate a significance value for the significance (in particular for the priority) of the first communication connection.

Another aspect describes a software (SW) program. The SW program can be configured to be executed on a processor and to thereby carry out the method described in this document.

Another aspect describes a non-transitory computer-readable storage medium. The storage medium may comprise an SW program that is configured to be executed on a processor and to thereby carry out the method described in this document.

Another aspect describes a significance message (in particular a message according to the CCC standard and/or protocol) which is provided for the purpose of being sent by a vehicle via a communication connection to a (key) device, wherein the device is designed to remotely control a vehicle function of the vehicle via the communication connection. The significance message can indicate a significance value for the significance of the communication connection.

It should be noted that the methods, apparatuses and systems described in this document may be used both on their own and in combination with other methods, apparatuses and systems described in this document. Furthermore, any aspects of the methods, apparatuses and systems described in this document may be combined with one another in a wide variety of ways. The features of the claims may in particular be combined with one another in a wide variety of ways. Furthermore, features in parentheses are to be understood as optional features.

### BRIEF DESCRIPTION OF THE DRAWINGS

FIG. 1a shows an exemplary digital access system of a vehicle;

FIG. 1b shows an exemplary usage situation for a digital access system;

FIG. 2a shows exemplary messages between a vehicle and a digital key device;

FIG. 2b shows an exemplary sequence of connection events and connection intervals;

FIG. 3a shows an exemplary key device having communication connections to a multiplicity of vehicles;

FIG. 3b shows an exemplary protocol stack for communication between a vehicle and a key device; and

FIG. 4 shows a flowchart of an exemplary method for defining the significance of a vehicle communication connection.

As explained at the outset, the present document deals with increasing the energy efficiency and/or reliability of the remote control of a vehicle function using a key device which is designed to simultaneously remotely control vehicle functions in a plurality of different vehicles.

### DETAILED DESCRIPTION OF THE DRAWINGS

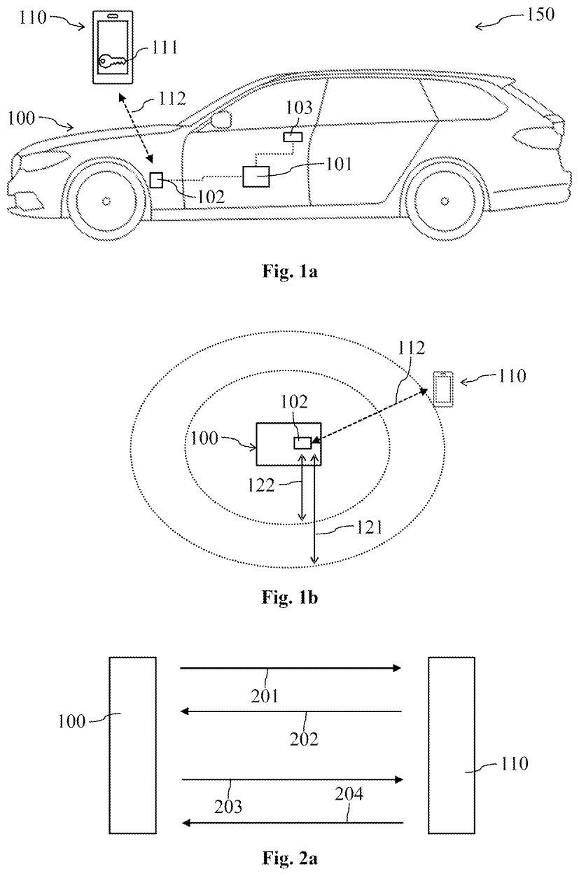

FIG. 1a shows an exemplary (access) system 150 which comprises at least one vehicle 100 and a digital key device 110. The digital key device 110 is typically a portable electronic device, such as a smartphone or a tablet PC, wherein a digital key 111 is stored on the portable electronic device. The digital key 111 may be stored in a protected memory area, in particular in a so-called “secure element”, of the portable electronic device (such as the user device).

The digital key device 110 is designed to communicate with a communication unit 102 of the vehicle 100 via one or more different wireless communication connections 112. The different communication connections 112 can be used for different purposes. In particular, a Bluetooth Low Energy (BLE) communication connection 112 can be used to
determine the distance and/or relative position between the digital key device 110 and the vehicle 100 (in particular on the basis of the signal strength, in particular the RSSI (Received Signal Strength Indicator), of the radio signals interchanged between the vehicle 100 and the device 110; and/or using BLE channel sounding (mode 2/phase-based measurements); and/or
interchange data between the digital key device 110 and the vehicle 100 (for example a control command for controlling a vehicle function 103, such as the unlocking of a door and/or the opening or closing of a window and/or the activation or deactivation of a heating function and/or the activation or deactivation of the drive motor of the vehicle 100).

Alternatively, or additionally, an ultra-wideband (UWB) communication connection 112 can be used to determine the position of the device 110 relative to the vehicle 100 with a relatively high degree of accuracy. Determining the position of the device 110 using the UWB communication connection 112 can be referred to as UWB ranging.

A (control) apparatus 101 of the vehicle 100 may be designed to control at least one vehicle function 103 of the vehicle 100 depending on the communication between the device 110 and the vehicle 100, as illustrated in FIG. 1b. In this context, the digital key 111 of the device 110 can be verified, in particular authenticated. Furthermore, after successful authentication, one or more vehicle functions 103 can be controlled, in particular depending on
the distance between the device 110 and the vehicle 100;
the position of the device 110 relative to the vehicle 100; and/or
a control command that is sent from the device 110 to the vehicle 100 via a communication connection 112.

In an exemplary system 150, a BLE communication connection can be established 112 between the device 110 and the vehicle 100 as soon as the distance between the device 110 and the vehicle 100 is equal to or less than a first distance threshold value 121. This allows the user to remotely control one or more vehicle functions 103 using the device 110. Typically, the vehicle 100 indicates the availability of a BLE communication connection 112 repeatedly, e.g. at a certain frequency. From the first distance threshold value 121, the device 110 (which may also be referred to as “user equipment” (UE)) receives the indicator message from the vehicle 100 and the BLE communication connection 112 can then be established between the device 110 and the vehicle 100. The first distance threshold value 121 may depend on the communication capabilities of the device 110, the environment of the vehicle 100 and/or the device 110, and/or the position of the device 110 relative to the vehicle 100.

Furthermore, a UWB communication connection 112 can be established between the device 110 and the vehicle 100 as soon as the distance between the device 110 and the vehicle 100 is equal to or less than a second distance threshold value 122 (which may be less than the first distance threshold value 121 and/or which may depend on the communication capabilities of the device 110). Based on the UWB communication connection 112, the location of the device 110 can be determined with a relatively high degree of accuracy. One or more additional vehicle functions 103 can possibly be controlled via the UWB communication connection 112 (in addition to one or more functions 103 which can be controlled via the BLE communication connection 112).

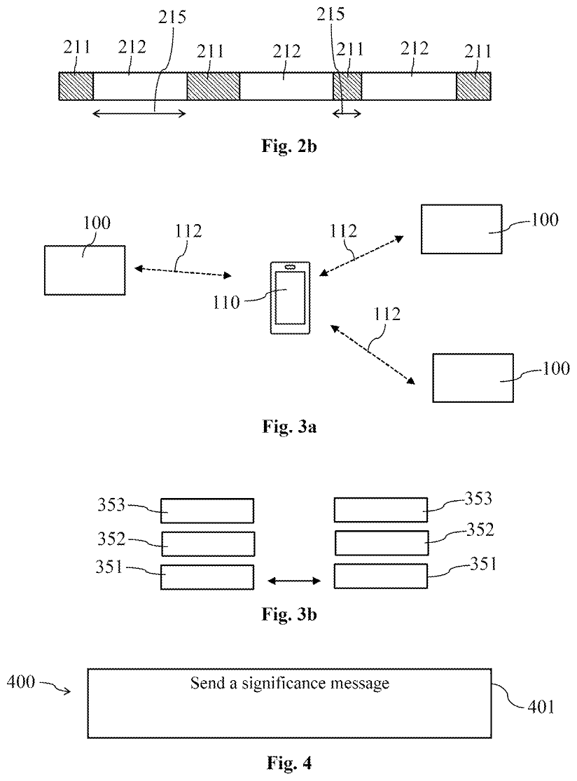

FIG. 2a illustrates the (possibly repeated, in particular periodic) sending of an indicator message 201 by the vehicle 100 in order to indicate that a (BLE) communication connection 112 to the vehicle 100 can be established. FIG. 2 further shows a response message 202 which is sent from the device 110 to the vehicle 100 in response to the receipt of an indicator message 201 in order to establish the communication connection 112.

Following the establishment of the (BLE) communication connection 112, messages 203, 204 can be interchanged between the vehicle 100 and the device 110 via the communication connection 112, e.g. in order to remotely control a vehicle function 103. The messages 203, 204 are transmitted in so-called “connection events”, where the connection events may have a certain time limit. Between directly successive “connection events” there is typically a so-called “connection interval”, in which no messages 203, 204 can be interchanged between the vehicle 100 and the device 110. The insertion of connection intervals between connection events typically leads to a reduction in the energy consumption of the communication between the vehicle 100 and the device 110, since the vehicle 100 and/or the device 110 can switch to an energy-saving mode in the individual connection intervals (since the receipt of a message 203, 204 is not expected in the individual connection intervals).

FIG. 2b illustrates a temporal sequence of connection events 211 (for transmitting messages 203, 204) and connection intervals 212 (for reducing the energy consumption). The temporal length 215 of the individual connection intervals 212 can be defined (if necessary while establishing the communication connection 112 between the vehicle 100 and the device 110). The length 215 can be, for example, between 7.5 ms and 4 s, possibly 30 ms as standard. In this case, a shortening of the connection intervals 212 typically leads to a reduction in the latency of the remote control of a vehicle function 103 (but to an increase in the energy consumption). On the other hand, an extension of the connection intervals 212 typically leads to an increased latency of the remote control of a vehicle function 103, but to a reduction in the energy consumption.

The temporal length 215 of the individual connection events 211 may depend on the amount of data to be transferred in the respective connection event 211. If no control messages 203, 204 are to be transferred, one or more (relatively short) data packets can be transferred in order to allow the vehicle 100 and/or the device 110 to check the continuity of the communication connection 112.

In the context of a (BLE) communication connection 112, one of the two communication partners (typically the device 110) has the status of a so-called “central”, and the other communication partner (typically the vehicle 100) has the status of a so-called “peripheral”. The one or more connection parameters of the communication connection 112, in particular the length 215 of the connection intervals 212, can be defined by the “central” if necessary.

As illustrated by way of example in FIG. 3a, the key device 110 may have a multiplicity of (BLE) communication connections 112 to a corresponding multiplicity of vehicles 100. The device 110 typically has only a single transmitting and/or receiving unit for carrying out the communications via the multiplicity of (BLE) communication connections 112. In other words, the device 110 can have limited total resources for carrying out the multiplicity of communications. This can lead to conflicts between the different communication connections 112. In particular, this can lead to the fact that the temporal lengths 215 of the connection intervals 212 (e.g. 30 ms each) defined for the individual communication connections 112 cannot be adhered to. Alternatively, or additionally, this can lead, according to the order in which the individual communication connections 112 are established, to the temporal length 215 of the connection intervals 212 for the individual communication connections 112 increasing, with the result that a (possibly significantly) greater temporal length 215 is defined for the communication connection 112 established last than for the communication connection 112 established first. This may lead to an impairment of the quality of the remote control of vehicle functions 103 in one or more vehicles 100 which have a communication connection 112 having a relatively great temporal length 215 of the connection intervals 212.

In the context of the communication between a vehicle 100 and the device 110, a significance message 203, 204, which informs the respective other communication partner about the significance (in particular about the priority) of the communication, can be sent from the vehicle 100 to the device 110 and/or from the device 110 to the vehicle 100. The significance of the communication between the vehicle 100 and the device 110 may depend, for example, on the vehicle function 103 which is intended to be remotely controlled via the communication connection 112. In this case, it may be possible to resort to a predefined significance catalog which indicates the significance, in particular the priority, of the respective vehicle function 103 for different vehicle functions 103 in each case.

The temporal length 215 of the connection intervals 212 for the individual communication connections 112 can be defined depending on the significance, in particular priority, determined for the respective communication connection 112. If necessary, this can be done independently of the order in which the individual communication connections 112 are established.

For example, for the first communication connection 112 between the device 110 and a first vehicle 100, a first length 215 for the connection intervals 212 can be defined (e.g. 30 ms). The first length 215 can be dependent on or independent of the significance of the first communication connection 112 (determined on the basis of the one or more significance messages 203, 204).

In the context of establishing an additional, second communication connection 112 between the device 110 and an additional, second vehicle 100, the first significance of the first communication connection 112 and the second significance of the second communication connection 112 (determined on the basis of the one or more significance messages 203, 204) can be compared with each other in order to
define the second length 215 for the connection intervals 212 of the second communication connection 112; and
if necessary, change the first length 215 for the connection intervals 212 of the first communication connection 112.

For example, the first length 215 can be increased when the comparison indicates that the second communication connection 112 has a higher second significance than the first significance of the first communication connection 112. On the other hand, a greater second length 215 than the first length 215 can be defined for the second communication connection 112 when the comparison indicates that the second communication connection 112 has a lower second significance than the first significance of the first communication connection 112.

In the current CCC specification for digital vehicle keys 111, the recommended value 215 for the Bluetooth connection interval 212 is 30 ms. If a plurality of vehicles 100 are simultaneously connected to a single key device 110, it may no longer be possible, due to the limited total resources in the key device 110, to maintain the value 215 of 30 ms for each of the individual communication connections 112. Typically, Bluetooth Low Energy, Bluetooth Classic and WiFi share the same resources (e.g. the same antenna) in an electronic device 110. This document describes measures that allow different connection priorities to be defined in order to enable the device 110 to define and/or adjust the values 215 of the connection intervals 212 for the different communication connections 112 based on the different priorities.

This document defines a DCK (Digital Car Key) subevent (i.e. a significance message) 203 in which the vehicle 100 informs the device 110 of the connection priority of the communication connection 112 between the vehicle 100 and the device 110. In this case, the vehicle 100 can change this priority over time (by sending a new significance message 203), e.g. depending on the respectively used and/or controlled vehicle function 103. For example, a higher priority can be defined for remotely controlled parking than for another vehicle function 103.

Thus, a DCK subevent 203 (i.e. a significance message) is described, which is sent from a vehicle 100 to the key device 110. For example, the subevent 203 can have the following values: Low prio, medium prio, high prio. For example, the vehicle 100 can specify a high priority in the subevent 203 if a delay-critical function 103 such as RCP (Remote Control Parking) is used. The device 110 can then define a certain temporal length 215 (e.g. 30 ms) of the connection intervals 212 for this connection 112.

It can thus be made possible for a vehicle 100, by sending a significance message 203, to inform the device 110 (which possibly has the status of the “central” of the communication connection 112) about the significance, in particular about the priority, of the communication connection 112, in particular about the significance of the vehicle function 103 which is controlled via the communication connection 112.

The device 110 may be designed to determine the significance of the respective communication connection 112 for a multiplicity of communication connections 112 in each case. Furthermore, the device 110 may be configured to define and, if necessary, to adjust one or more connection parameters, in particular the length 215 of the connection intervals 212, of the individual communication connections 112 depending on the significance of the multiplicity of communication connections 112. The significance of the individual communication connections 112 can be determined on the basis of the significance messages 203 which were sent by the individual vehicles 100.

FIG. 3b shows an exemplary protocol stack (e.g. according to the OSI (Open Systems Interconnection) model). In this case, a (BLE) communication connection 112 can be provided via a physical layer 351. The control of the communication connection 112 can be provided via a layer 352 thereabove (e.g. a data link layer, a network layer and/or a transport layer). The CCC protocol for the remote control of a vehicle function 103 can be provided in an application layer 353 thereabove. The significance message 203 described in this document can be a message of the CCC protocol and/or a message on the application layer 353.

FIG. 4 shows a flowchart of an exemplary (possibly computer-implemented) method 400 for controlling a vehicle function 103 of a first vehicle 100 via a first (BLE) communication connection 112 between the first vehicle 100 and a device 110. The device 110 can be designed, for the remote control of vehicle functions 103 (on different vehicles 100), to operate a multiplicity of different (BLE) communication connections 112 to a corresponding multiplicity of different vehicles 100.

The method 400 comprises sending 401 a significance message 203 (in particular a priority message) to the device 110 via the first communication connection 112. In this case, the significance message 203 can indicate the significance value for the significance (in particular the priority) of the first communication connection 112. A connection parameter of the first communication connection 112 can then be defined depending on the significance message 203.

The measures described in this document enable efficient, reliable and convenient remote control of one or more vehicle functions 103 of a vehicle 100 using a device 110, even when the device 110 simultaneously remotely controls vehicle functions 103 in a plurality of different vehicles 100.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

The present subject matter is not restricted to the examples shown. In particular, it should be noted that the description and the figures are intended to illustrate the principle of the proposed methods, apparatuses and systems only by way of example.

The foregoing disclosure has been set forth merely to illustrate the present subject matter and is not intended to be limiting. Since modifications of the disclosed examples incorporating the spirit and substance of the present subject matter may occur to persons skilled in the art, the present subject matter should be construed to include everything within the scope of the appended claims and equivalents thereof.

What is claimed is:

1. A portable electronic device for controlling a vehicle function via a first communication connection between a first vehicle and a device, comprising:
a processor; and
a memory in communication with the processor and configured to store instructions executable by the processor to configure the portable electronic device to:
operate a multiplicity of different communication connections to a corresponding multiplicity of different vehicles; and
send a significance message to the device via the first communication connection, wherein
the significance message indicates a significance value for a significance of the first communication connection.

2. The portable electronic device according to claim 1, wherein
the significance message is configured to prompt the device to define a connection parameter that is dependent on the significance value for the first communication connection.

3. The portable electronic device according to claim 1, wherein
the significance message indicates a priority level from a predefined set of different priority levels; and/or
the significance value for the significance of the first communication connection indicates a priority of the first communication connection in comparison with one or more other communication connections.

4. The portable electronic device according to claim 1, wherein the memory further comprises instructions to configure the portable electronic device to:
determine the significance value for the significance of the first communication connection between the device and the first vehicle based on the vehicle function that is intended to be remotely controlled or is remotely controlled via the first communication connection.

5. The portable electronic device according to claim 4, wherein the memory further comprises instructions to configure the portable electronic device to:
determine the significance value for the significance of the first communication connection between the device and the first vehicle using a significance catalog, wherein
the significance catalog indicates a respective corresponding significance value for different vehicle functions.

6. The portable electronic device according to claim 1, wherein the memory further comprises instructions to configure the portable electronic device to:
receive a control command for remotely controlling the vehicle function of the first vehicle via the first communication connection.

7. The portable electronic device according to claim 2, wherein
the first communication connection includes a Bluetooth Low Energy (BLE) communication connection; and
the connection parameter comprises a temporal length of connection intervals of the BLE communication connection.

8. The portable electronic device according to claim 1, wherein the memory further comprises instructions to configure the portable electronic device to:
cause the first communication connection between the device and the first vehicle to be established considering a digital key, wherein
the digital key configured according to a Car Connectivity Consortium (CCC) standard Release 3.

9. The portable electronic device according to claim 8, wherein
the significance message is a message according to the CCC standard; and/or
the significance message is sent on a same protocol layer as the digital key.

10. A method for controlling a vehicle function via a first communication connection between a first vehicle and a device, wherein the device is configured for remote control of vehicle functions to operate a multiplicity of different communication connections to a corresponding multiplicity of different vehicles, the method comprising:
sending a significance message to the device via the first communication connection, wherein
the significance message indicates a significance value for a significance of the first communication connection.

11. A significance message provided to be sent to a device by a vehicle via a communication connection, wherein the device is configured to remotely control a vehicle function of the vehicle via the communication connection, wherein
the significance message indicates a significance value for a significance of the communication connection.
